(19) United States
(12) Patent Application Publication
(10) Pub. No.: US 2018/0332512 A1
(43) Pub. Date: Nov. 15, 2018

(54) Secondary Cell Transmission

(71) Applicant: Nokia Solutions and Networks Oy, Espoo (FI)

(72) Inventors: Lars DALSGAARD, Oulu (FI); Elena VIRTEJ, Espoo (FI); Jari Petteri LUNDEN, Espoo (FI)

(73) Assignee: Nokia Solutions and Networks Oy, Espoo (FI)

(21) Appl. No.: 15/775,443

(22) PCT Filed: Nov. 16, 2015
(86) PCT No.: PCT/EP2015/076645

§ 371 Date: May 11, 2018

(51) Int. Cl. H04W 36/00

(52) U.S. Cl. CPC H04W 36/00835; H04W 84/045

(57) ABSTRACT

A technique including: detecting at a communication device a first cell meeting one or more cell signal conditions for secondary cell transmission for the communication device, which communication device is currently served by at least a primary cell of a cellular network; determining whether the first cell belongs to a set of potential secondary cells for the communication device including another cell that the communication device has currently reported to the cellular network as meeting one or more cell signal conditions for secondary cell transmission for the communication device; and deciding whether to report said first cell to said cellular network dependent on the result of said determining.

Transmitting data to/from a communication device served by at least a primary cell of a cellular network may comprise transmitting data via one or more secondary cells.

For example, data rates can be increased by using two or more component carriers (e.g. a primary cell carrier and a secondary cell carrier) for a single user session. The component carriers may, for example, be operated via more than one baseband unit involving simultaneous radio connections to two or more base stations.

Communication systems may be configured to use a mechanism for aggregating radio carriers to support wider transmission bandwidth. In LTE (Long Term Evolution), this mechanism is referred to as carrier aggregation (CA) and can, according to current specifications, support a transmission bandwidth up to 100 MHz. A communication device with reception and/or transmission capabilities for CA can simultaneously receive and/or transmit on multiple component carriers (CCs) corresponding to multiple serving cells, for which the communication device has acquired/monitors system information needed for initiating connection establishment. When CA is configured, the communication device has only one radio resource control (RRC) connection with the network. At RRC connection establishment/reestablishment or handover, one serving cell provides the non-access stratum (NAS) mobility information, such as tracking area identity information. At RRC connection (re)establishment or handover, one serving cell provides the security input. This cell is referred to as the primary serving cell (PCell), and other cells are referred to as the secondary serving cells (SCells). Depending on capabilities of the communication device, SCells can be configured to form together with the PCell a set of serving cells under CA. In the downlink, the carrier corresponding to the PCell is the downlink primary component carrier (DL PCC), while in the uplink it is the uplink primary component carrier (UL PCC). A SCell is configured by the network using RRC signaling before usage in order to provide necessary information, such as DL radio carrier frequency and physical cell identity (PCI) information, to the communication device. A SCell for which such necessary information has been provided to a communication device is referred to as configured cell for this communication device. The information available at the communication device after cell configuration includes information sufficient for carrying out Scell measurements at the communication device. A configured SCell is in a deactivated state after cell configuration for energy saving. In particular, when a SCell is deactivated, the communication device does not monitor/receive the physical dedicated control channel (PDCCH) or physical downlink shared channel (PDSCH) in the SCell. In other words, the communication device cannot communicate in a SCell after cell configuration, and the SCell needs to be activated before data transmission from/the communication device can be initiated in the SCell. LTE provides for a mechanism for activation and deactivation of SCells via media access control (MAC) control elements to the communication device. The primary cell could be the cell, operating on the primary frequency, in which the communication device either performs the initial connection establishment procedure or initiates the connection re-establishment procedure, or the cell indicated as the primary cell in the handover procedure The secondary cell is a cell, operating on a secondary frequency, which may be configured once an RRC connection is established and which may be used to provide additional radio resources Of course, in case of a dual connectivity, a secondary cell group (SCG) would include a primary Scell (PSCell) (e.g. the SCG cell in which the communication device is instructed to perform random access when performing the SCG change procedure, and the SCG cell on which the physical uplink control channel (PUCCH) is configured) and secondary SCells (according to 3GPP TS 36.331 V12.7.0 (2015-09)).

A communication system may be configured to support simultaneous communication with two or more access nodes. In LTE this mechanism is referred to as dual connectivity (DC). More specifically, a communication device may be configured in LTE to communicate with a master eNB (MeNB) and a secondary eNB (SeNB). The MeNB may typically provide access to a macrocell, while the SeNB may provide on a different radio carrier access to a relatively small cell, such as a picocell. Only the MeNB maintains for the communication device in DC mode a connection via an S1-MME interface with the mobility management entity (MME), i.e. only the MeNB is involved in mobility management procedures related to the communication device in DC mode. LTE supports two different user plane architectures for communication devices in DC mode. In the first architecture (split bearer) only the MeNB is connected via an S1-U interface to the serving gateway (S-GW) and the user plane data is transferred from the MeNB to the SeNB via an X2 interface. In the second architecture the SeNB is directly connected to the S-GW, and the MeNB is not involved in the transport of user plane data to the SeNB. DC in LTE reuses for the radio interface concepts introduced for CA in LTE. A first group of cells, referred to as master cell group (MCG), can be provided for a communication device by the MeNB and may comprise one PCell and one or more SCells, and a second group of cells, referred to as seconday cell group (SCG), is provided by the SeNB and may comprise a primary SCell (PSCell) with functionality similar to the PCell in the MCG, for example with regard to uplink control signaling from the communication device. This second group of cells may further comprise one or more SCells.

Aggregation of radio carriers for communication to/from a communication device and simultaneous communication with two or more access nodes may in particular be used for operating cells on unlicensed spectrum. Wireless communication systems may be licensed to operate in particular spectrum bands. A technology, for example LTE, may operate, in addition to a licensed band, in an unlicensed band. LTE operation in the unlicensed spectrum may be based on the LTE Carrier Aggregation (CA) framework where one or more low power secondary cells (SCells) operate in the unlicensed spectrum and may be either downlink-only or contain both uplink (UL) and downlink (DL), and where the primary cell (PCell) operates in the licensed spectrum and can be either LTE Frequency Division Duplex (FDD) or LTE Time Division Duplex (TDD). One proposal for operating LTE in unlicensed spectrum is Licensed-Assisted Access (LTE-LAA). Technologies like LTE-LAA may need to abide by certain rules, for example a clear channel assessment procedure, such as Listen-Before-Talk (LBT), in order to provide fair coexistence between LTE and other technologies such as Wi-Fi as well as between LTE operators. In some jurisdictions respective rules may be specified in regulations.

Deployment of small cells on licensed and unlicensed spectrum is a mechanism to enhance system capacity within the coverage area of a radio access network in a communication system. Small cells, such as picocells, may be deployed progressively in future radio access network to match the growth in demand for system capacity as the population of communication devices and data applications become more and more demanding. Small cells may typically be deployed in areas of high traffic requirements. This means that small cells may be deployed non-homogeneously resulting in non-uniformly distributed small cells. The overlap of coverage areas between some of the small cells may therefore be large in such non-homogeneous deployment.

A conventional multiple carrier transmission technique involves a communication device informing the network via a primary cell whenever another cell meets one or more cell signal conditions for multiple carrier transmission for the communication device, and the network then informing the communication device via the primary cell if the detected cell is configured as a secondary cell for multiple carrier transmission for the communication device, providing secondary cell configuration information to the communication device, and activating the secondary cell if there is data for transmission via the primary cell and/or the configured secondary cell to/from the communication device. The communication device also informs the network via the primary cell whenever a configured secondary cell stops meeting one or more cell signal conditions for multiple carrier transmission. The procedures for one example of a multiple carrier transmission technique are set out in 3GPP TS 36.331, 3GPP 36.321 and 3GPP TS 36.133.

The inventors for the present application have concluded that the above-described conventional signalling scheme may no longer be bearable in future communication systems providing access via a high number of carriers, for example carrier aggregation via up to 32 component carriers and/or dual connectivity with an increased number of component carriers per MCG and/or SCG. Simply using the conventional signalling scheme would mean that each SCell would need to be configured by the network using a radio resource control (RRC) message followed by an activation command prior to enabling scheduling of a communication device on a SCell. The network can take two approaches when configuring a SCell:
Known SCell: In this case the network receives a measurement report from the communication device including measurements from the SCell. Based on the reporting the network (immediately) configures the SCell—later followed by an activation command.
Unknown SCell: In this case the network has either not received a measurement report including the SCell, and the network relies on deployment knowledge or the network has received measurement report including the SCell—but longer time ago. In this case the network configures the SCell blindly followed by an activation command.

In both cases SCell configuration via RRC signalling and subsequent cell activation via MAC signalling per SCell is required before data transmission in the SCell to/from the communication device can be initiated.

The inventors for the present application have identified the challenge of providing an improved multiple carrier transmission technique. More particularly, the inventors have identified a need to reduce signalling between a communication device and the network relating to multiple carrier transmission. The inventors for the present application have also identified a need to provide a new signalling scheme for cell configuration and activation which reduces the signalling load/overhead in the primary cell.

There is hereby provided a method comprising: detecting at a communication device a first cell meeting one or more cell signal conditions for secondary cell transmission for the communication device, which communication device is currently served by at least a primary cell of a cellular network; determining whether the first cell belongs to a set of potential secondary cells for the communication device including another cell that the communication device has currently reported to the cellular network as meeting one or more cell signal conditions for secondary cell transmission for the communication device; and deciding whether to report said first cell to said cellular network dependent on the result of said determining.

According to one embodiment, said set of potential secondary cells consists of cells operating at the same carrier frequency.

According to one embodiment, said set of potential secondary cells consists of cells whose total collective coverage area is contiguous.

According to one embodiment, said one or more cell signals conditions for secondary cell transmission comprise one or more cell signal conditions for cell change.

There is also hereby provided a method comprising: transmitting for a communication device served by at least a primary cell of a cellular network an identification of at least one set of potential secondary cells for the communication device, wherein said identification is an indication to the communication device not to automatically report movement between cells in the same set of potential secondary cells.

According to one embodiment, each set of potential secondary cells consists solely of cells operating at the same carrier frequency.

According to one embodiment, each set of potential secondary cells consists solely of cells whose total collective coverage area is contiguous.

According to one embodiment, the method further comprises: monitoring radio signals from the communication device for an indication that one cell in a set of potential secondary cells meets one or more cell signal conditions for secondary cell transmission.

According to one embodiment, the method further comprises: in response to detecting an indication that one cell in a set of potential secondary cells meets one or more cell signal conditions for secondary cell transmission, monitoring radio signals from the communication device that a cell in the same set of potential secondary cells has stopped meeting one or more cell signal conditions for secondary cell transmission.

According to one embodiment, said one or more cell signals conditions for secondary cell transmission comprise one or more cell signal conditions for cell change.

There is also hereby provided an apparatus comprising: a processor and memory including computer program code, wherein the memory and computer program code are configured to, with the processor, cause the apparatus to: detect at a communication device a first cell meeting one or more cell signal conditions for secondary cell transmission for the communication device, which communication device is currently served by at least a primary cell of a cellular network; determine whether the first cell belongs to a set of potential secondary cells for the communication device including another cell that the communication device has currently reported to the cellular network as meeting one or more cell signal conditions for secondary cell transmission for the communication device; and decide whether to report said first cell to said cellular network dependent on the result of said determining.

According to one embodiment, said set of potential secondary cells consists of cells operating at the same carrier frequency.

According to one embodiment, said set of potential secondary cells consists of cells whose total collective coverage area is contiguous.

According to one embodiment, said one or more cell signals conditions for secondary cell transmission comprise one or more cell signal conditions for cell change.

There is also hereby provided an apparatus comprising: a processor and memory including computer program code, wherein the memory and computer program code are configured to, with the processor, cause the apparatus to: transmit for a communication device served by at least a primary cell of a cellular network an identification of at least one set of potential secondary cells for the communication device, wherein said identification is an indication to the communication device not to automatically report movement between cells in the same set of potential secondary cells.

According to one embodiment, each set of potential secondary cells consists solely of cells operating at the same carrier frequency.

According to one embodiment, each set of potential secondary cells consists solely of cells whose total collective coverage area is contiguous.

According to one embodiment, the memory and computer program code are further configured to, with the processor, cause the apparatus to: monitor radio signals from the communication device for an indication that one cell in a set of potential secondary cells meets one or more cell signal conditions for secondary cell transmission.

According to one embodiment, the memory and computer program code are further configured to, with the processor, cause the apparatus to: in response to detecting an indication that one cell in a set of potential secondary cells meets one or more cell signal conditions for secondary cell transmission, monitor radio signals from the communication device that a cell in the same set of potential secondary cells has stopped meeting one or more cell signal conditions for secondary cell transmission.

According to one embodiment, said one or more cell signals conditions for secondary cell transmission comprise one or more cell signal conditions for cell change.

There is also hereby provided a computer program product comprising program code means which when loaded into a computer controls the computer to: detect at a communication device a first cell meeting one or more cell signal conditions for secondary cell transmission for the communication device, which communication device is currently served by at least a primary cell of a cellular network; determine whether the first cell belongs to a set of potential secondary cells for the communication device including another cell that the communication device has currently reported to the cellular network as meeting one or more cell signal conditions for secondary cell transmission for the communication device; and decide whether to report said first cell to said cellular network dependent on the result of said determining.

There is also hereby provided a computer program product comprising program code means which when loaded into a computer controls the computer to: transmit for a communication device served by at least a primary cell of a cellular network an identification of at least one set of potential secondary cells for the communication device, wherein said identification is an indication to the communication device not to automatically report movement between cells in the same set of potential secondary cells.

Embodiments of the present invention are described in detail hereunder, by way of example only, with reference to the accompanying drawings, in which:

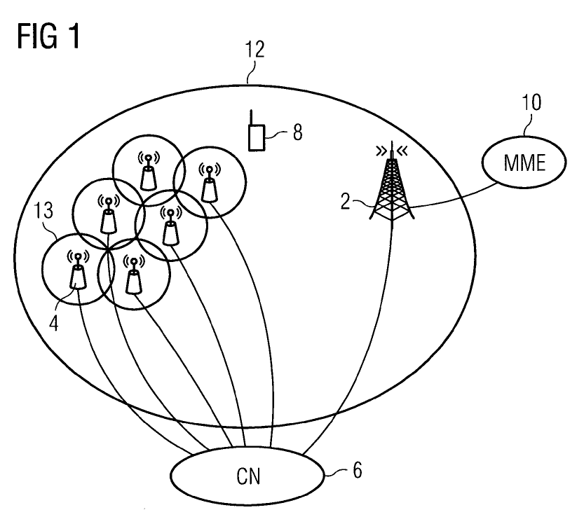

FIG. 1 illustrates a communication device served by a macro cell whose coverage area is populated by cells of smaller coverage area;

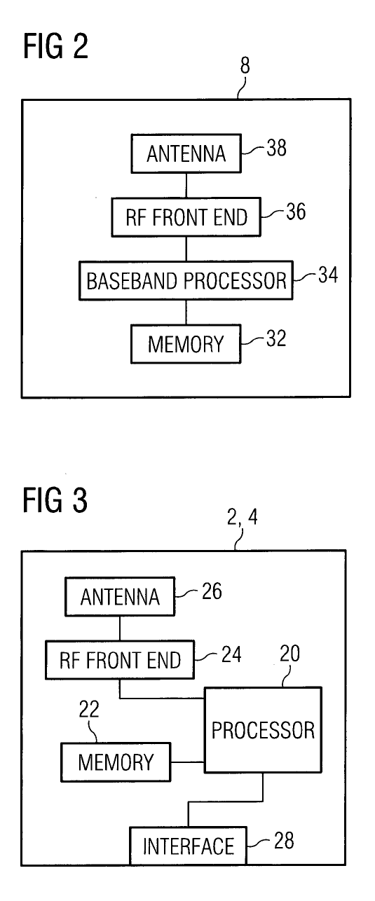

FIG. 2 illustrates an example of apparatus for use at the eNodeBs (eNB) of FIG. 1;

FIG. 3 illustrates an example of apparatus for use at the communication device of FIG. 1;

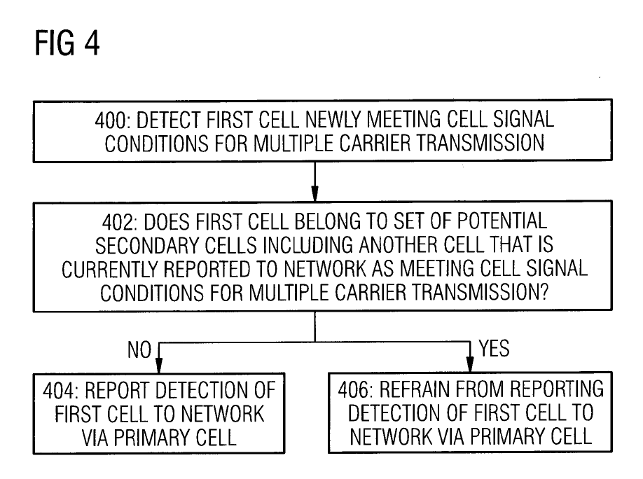

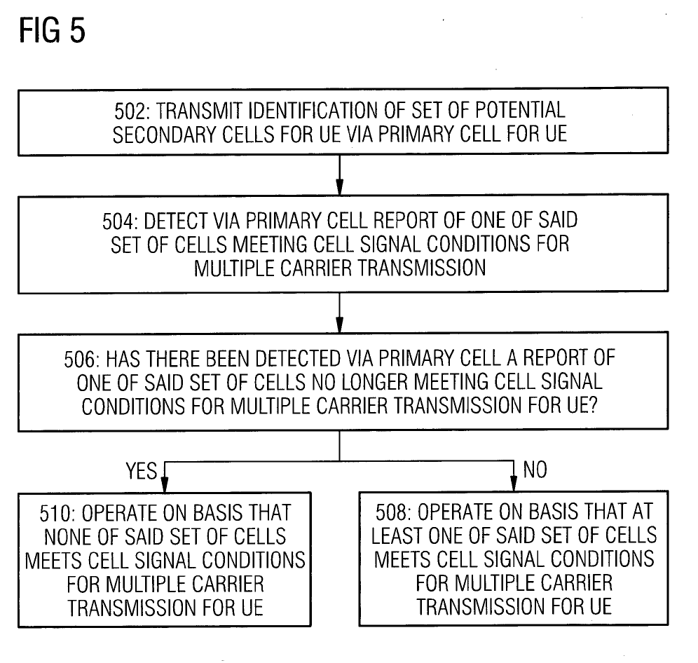

FIG. 4 illustrates an example of operations at a communication device according to an embodiment of the present invention;

FIG. 5 illustrates an example of operations at a primary cell eNB according to an embodiment of the invention; and

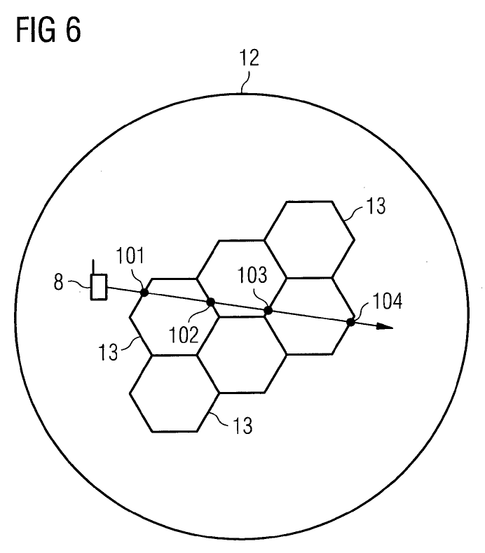

FIG. 6 illustrates the movement of a communication device through the cluster of small cells of FIG. 1 within the coverage of the macro cell of FIG. 1.

A technique according to an embodiment of the present invention is described in detail below for the example of a E-UTRAN network according to LTE (Long Term Evolution), but the same technique is applicable to any other access network with secondary cell transmission capability (e.g. multiple carrier transmission capability such as dual connectivity capability), including proposed new generation networks such as Further Enhanced LTE (e.g. LTE-Advanced Pro) and 5G.

FIG. 1 schematically shows an example of part of a EUTRAN cellular radio access network, comprising a macro cell operated by a macro eNodeB (eNB) 2 having a coverage area populated with smaller cells having smaller coverage areas and operated by respective eNodeBs 4 at one or more different carrier frequencies (component carriers) to the macro cell.

FIG. 1 only shows a single macro eNB 2, but a LTE cellular network will typically comprise thousands of macro eNBs providing substantially continuous coverage over a wide geographical area. Similarly, FIG. 1 only shows 6 small cells within the coverage area 12 of the macro cell, but the coverage area of the macro cell may be populated by e.g. hundreds of small cells.

FIG. 1 shows the coverage area 12 of one macro cell operated via the macro eNB 2, but a plurality of macro cells having different coverage areas and/or different carrier frequencies may be operated via the same macro eNB 2.

The macro eNB 2 is connected to a mobile management entity (MME), which manages the handover of a communication device (UE) 8 between LTE cells. The macro eNB 2 and small cell eNBs 4 are also connected to a core network (CN) 6. A LTE cellular radio access network may also include other elements, but these are not shown in FIG. 1 for conciseness.

According to one example of a dual-connectivity multiple carrier transmission technique in the example illustrated in FIG. 1: user plane data for a single user session is simultaneously transferred between the UE 8 and the core network 6 both via (a) a radio connection between the UE 8 and the macro eNB 2 at one carrier frequency (component carrier), and (b) one or more radio connections between the UE 8 and a respective small cell eNB 4 at different carrier frequencies (component carriers), all under the radio resource control (RRC) of the macro eNB 2. The macro eNB 2 functions as master node (MeNB) and the macro cell as primary cell (PCell), and the one or more small cell eNBs 4 function as secondary nodes and the small cells as secondary cells. Each eNB is in charge of allocation of its own radio resources (scheduling) to UE 8, but radio resource control (RRC) of the UE's connection, i.e. configuration of connection parameters, bearer setup/modification, control of measurements and mobility etc. is in MeNB (or primary cell). There are two different MACs for data transmission: one via MeNB and one via secondary eNB cell.

It is proposed that multiple carrier transmission may involve a high number of component carriers (e.g. up to 32 component carriers), and may therefore involve a high number of e.g. small cells as secondary cells (SCells).

FIG. 2 shows a schematic view of an example of apparatus for UE 8. The communication device (UE) 8 may be used for various tasks such as making and receiving phone calls, receiving and sending data from and to a data network, and experiencing, for example, multimedia or other content. The UE 8 may be any device at least capable of both recovering data/information from radio signals transmitted by the macro and small cell eNBs 2, 4, and transmitting radio signals including data/information recoverable by the macro and small cell eNBs 2, 4. Non-limiting examples of user equipment (UE) 8 include smartphones, tablets, personal computers, and devices without any user interface, such as devices that are designed for machine type communications (MTC).

With reference to FIG. 2, a baseband processor 34, operating in accordance with program code stored at memory 32, controls the generation and transmission of radio signals via radio-frequency front end 36 and antenna 38. The RF front end may include an analogue transceiver, filters, a duplexer, and antenna switch. Also, the combination of antenna 38, RF front end 36 and baseband processor 34 recovers data/information from radio signals reaching UE 8 from e.g. macro eNB 2 and small cell eNBs 4. The UE 8 may also comprise an application processor (not shown) that generates user data for transmission via radio signals, and processes user data recovered from radio signals by baseband processor 34 and stored at memory 32.

The application processor and the baseband processor 34 may be implemented as separate chips or combined into a single chip. The memory 32 may be implemented as one or more chips. The memory 32 may include both read-only memory and random-access memory. The above elements may be provided on one or more circuit boards.

The UE may include additional other elements not shown in FIG. 2. For example, the UE 8 may include a user interface such as key pad 201, voice commands, touch sensitive screen or pad, combinations thereof or the like, via which a user may control operation of the UE 8. The UE 8 may also include a display, a speaker and a microphone. Furthermore, the UE 8 may comprise appropriate connectors (either wired or wireless) to other devices and/or for connecting external accessories (e.g. hands-free equipment) thereto.

FIG. 3 shows an example of apparatus for use at each of the macro and small cell eNBs 2, 4 of FIG. 1. A broadband processor 20, operating in accordance with program code stored at memory 22, (a) controls the generation and transmission of radio signals via the combination of radio-frequency front end 24 and antenna 26; and (b) recovers data from radio signals reaching the eNB from e.g. UE 8. The RF front end may include an analogue transceiver, filters, a duplexer, and antenna switch. Both the processor 20 and the memory 22 may be implemented as one or more chips. The memory 22 may include both read-only memory and random-access memory. The above elements may be provided on one or more circuit boards. The apparatus also comprises an interface 28 for transferring data to and from one or more other network nodes such as e.g. the core network 6 and other eNBs.

It should be appreciated that the apparatus shown in each of FIGS. 2 and 3 described above may comprise further elements which are not directly involved with the embodiments of the invention described hereafter.

In this non-limiting example, the UE 8 is in RRC connected mode with macro eNB 2 via the primary macro cell whose coverage area 12 is populated by a cluster of small cell eNBs 4 having smaller coverage areas 13; and all six small cells in the cluster are operated at the same carrier frequency (component carrier), and collectively may provide a contiguous coverage area, but a cluster of cells may not necessarily provide a contiguous coverage area.

In an example embodiment, the network configures a list or number of potential SCells on a carrier, i.e. a cluster of SCells to be regarded as providing radio access resources. The configuration of the SCell cluster is done on a per carrier basis and the cluster could contain one or more SCell(s). The cells of a cluster may be located e.g. such that they provide continuous coverage within an area, but non-contiguous grouping of cells to form a cluster is also possible. The cells included in the cluster may be identified with a cell specific identifier e.g. PCID. A cluster may be identified by a cluster ID. The network may configure UE with measurement event or reporting that relates to one or more clusters of cells. For example, a UE may report when it enters or leaves a cluster (for example, the report from the UE may contain measurements of the strongest cells and/or possibly corresponding cluster ID). The UE may be considered to be in a cluster when at least one of the cells of the cluster is measured to be stronger than a configured threshold (e.g. reference signal received power (RSRP) or reference signal received quality (RSRQ) measurement). Similarly, a UE may be considered to have left a cluster when none of the cells in the cluster is fulfilling a configured quality condition (e.g. RSRP or RSRQ conditions are not fulfilled anymore). In addition, hysteresis and time-to-trigger could apply to these events as well. In some embodiments, for cells belonging to a configured cluster, the UE may report only cluster-level events (e.g. entering or leaving a cluster) and not report events within the cluster (e.g. moving between cells in the same cluster). In some embodiments, the cluster event (i.e. entering or leaving a cluster) can be applied even if the cells within the cluster (belonging to the cluster) have been individually configured. In this case, the network may configure UE with a cluster by signalling the set of cells belonging to that cluster (e.g. PCIDs and possibly a cluster ID). In an example embodiment, the UE is pre-configured with a cluster of cells on a carrier. For example, the network may signal via the primary cell pre-configuration information that is shared by multiple cells of the cluster, and also a list or range of PCIDs of the clustered cells sharing the pre-configuration information. These cells are considered by UE as preconfigured until a remainder of the configuration information is obtained (later). Then UE applies the configuration specific to the cell (as identified in the remainder of the configuration information) and also applies the configuration (common to cells in the cluster) identified in the preconfiguration information.

In some embodiments, the configuration information provided to the UE when entering a cluster may not be per SCell detailed configuration but simply a list of PCIDs or simply an indication of all cells on a given carrier. Alternatively, all cells on a carrier may be indicated (i.e. all 512 PCIDs in LTE or simply leaving out any cell identity details). Based on the configuration, the UE is configured with a number of potential SCell(s) on a given carrier. When UE detects any of the configured clustered SCell(s) on the carrier, such a detected SCell may be regarded as being a configured SCell by the UE. In the case that a cluster comprises all cells on a given carrier, any detected cell on the carrier would be regarded as a SCell.

In one embodiment, the configuration information that the UE needs to use a secondary cell (e.g. one or more of bandwidth information, various channel (e.g. PDSCH, PHICH, PUCCH etc.) information, random access configuration, time division duplex (TDD) frame structure, antenna information) may be shared by all cells within the cluster, and the network may provide this shared configuration information via the primary cell in response to a report that the UE has entered the cluster). The network may hereafter activate the SCell without any further need for configuration.

In an alternative embodiment, the UE may obtain detailed configuration information for individual cells in a cluster directly from the respective cell, for example from information broadcast in the cell, and the network may only provide pre-configuration information via the primary cell in response to a report that the UE has entered the cluster. The pre-configuration information may contain configuration information that is common to all the cells in the cluster for that UE. The pre-configuration information may include basic system information needed for accessing the cell, for example, the system information included in the MIB and first two SIBs (MasterInformationBlock, SystemInformationBlockType1, SystemInformationBlockType2) broadcast by the cell. In addition, depending on the deployment/configuration of the network, the cells within a cluster may share other common configuration parameters, such as, e.g. common cross-carrier scheduling configuration (CrossCarrierSchedulingConfig-r10) parameters, common UL power control parameters (UplinkPowerControlDedicated), etc.

Said detailed configuration information for an individual SCell may be signaled at a later stage to the UE, for example when the UE connects to the individual SCell. Such information may include cell specific information such as CSI-RS-Config information, SoundingRS-UL-Config information, and/or antenna configuration information (AntennaInfoCommon, AntennaInfoDedicated-r10, AntennaInfo-r10). The detailed configuration information for a particular SCell may override some of the parameters included in the common, pre-configuration information.

In some embodiment examples, pre-configuration information includes information needed for accessing a cell and detailed configuration information includes the cell-specific information needed for UE to operate in that cell. Based on the pre-configuration information, UE may e.g. make measurements for any of the cell in the cluster, and access any cell in the cluster. The detailed configuration information for a secondary cell may be signalled at a later stage to the UE, for example when the UE connects to the secondary cell, and may include further parameters or other configuration information needed for UE to operate in the cell.

In an alternative embodiment, the UE acquires complete configuration information for one or more individual cells within a cluster via the primary cell after reporting movement into a cell belonging to the cluster, together with an indication that the cells belong to a cluster.

In one non-limiting example, existing E-UTRAN measurement events may be used. The UE may be configured e.g. with event A4 enter and leave for triggering a transmission from the UE informing the network that the UE has entered or left a cell cluster/set. The event A6 may be used for determining a cell change within a cell cluster/set at UE. One example is illustrated in FIG. 6, which shows a UE moving through the cell cluster of FIG. 1 along the path indicated by the arrow in FIG. 6.

A) At location 101: the UE detects a clustered cell meeting the A4 event conditions; the UE determines that it has entered a cell cluster;

B) At location 104: the UE no longer detects any clustered cell meeting the A4 event conditions; the UE determines that it has left the cell cluster;

C) At locations 102 and 103: the UE detects another cell within the cluster meeting the A6 event conditions; the UE determines that it has moved between cells within the same cluster.

At location 101: the UE may report to the network that UE has entered the cluster and the radio resources made available by the (any) cell in the cluster are available and can be used. At Location 104: the UE may inform the network that it leaves the cluster. At cell changes within the cluster of cells (locations 102 and 103) e.g. potentially triggered by event A6—the UE may not automatically send any indication of the cell change to the network. The UE may inform the network e.g. using normal measurement reporting when it enters the cluster—e.g. at location 101 of FIG. 6. When UE leaves the coverage of the cluster (e.g. at location 104 of FIG. 6), the UE may again inform the network. When the UE roams/moves around within the cluster (and e.g. enters and leaves the coverage of different cells within the defined cluster) the UE may not automatically inform the network.

Inside a cell cluster, a cell change may, for example, be determined using event A6, which is the connected mode event developed for handling SCell changes. Using event A6 leaves flexibility on the network side to tune the intra-cluster cell change rules. Alternatives include re-using idle mode reselection or re-using other connected mode events e.g. event A3.

When the network is ready to activate a secondary cell for the UE, the primary eNB may transmit a request for the UE to transmit a report identifying which cell within the secondary cell cluster is currently the strongest cell for the UE (e.g. which cell currently is detected to have the highest RSRP or RSRQ). Alternatively, the network can page the UE within the cluster. Once the network knows the strongest cell for the UE within the secondary cell cluster, the network can activate that cell by e.g. MAC signalling.

FIGS. 4 and 5 illustrate an example of operations at macro eNB 2 and UE 8 according to one embodiment for this example. All operations carried out by the processor 34 follow program code stored at memory 32; and all operations carried out by the processor 20 follow program code stored at memory 22.

The macro eNB processor 20 transmits via RF front end 36 and antenna 38 an identification for UE 8 of all six small cells as a set of configured potential secondary cells for UE 8 (STEP 502). This transmission can be made at any time whilst the UE is listening to transmissions by the macro eNB 2. This identification may comprise a list of the physical cell identifiers (PCIDs) for all six small cells. Alternatively, the identification of a cluster of configured potential secondary cells for the UE may comprise a list of ranges of PCID numbers, which may be more efficient when the cluster of configured potential secondary cells contains a relatively high number of cells. Further alternatively, the network may designate all small cells operating at a particular carrier frequency (component carrier) as potential configured secondary cells for the UE 8, and the identification of a cluster of configured potential secondary cells for the UE 8 may then simply comprise an identification of that carrier frequency. In some embodiments, ‘All cells’ indication is also an option e.g. for LAA carriers and/or other offloading carriers.

As UE 8 moves through the coverage area of the macro primary cell, the UE processor 34 measures one or more parameters (e.g. RSRP and/or RSRQ) of other cell reference signals reaching the UE 8 and stores the results of those measurements in memory 32. The processor 34 compares the measured values of one or more reference signal parameters against one or more threshold values also stored at memory 32, and may determine that a detected cell newly meets one or more cell signal conditions for multiple carrier transmission for the UE 8 (STEP 400). In this example, the cell signal conditions for multiple carrier transmission are the same as the cell signal conditions for cell change, and reference is made in the remainder of this description to cell signal conditions for cell change, but other cell signal conditions for multiple carrier transmission can be used. For example, the measurement events A4 and A6 specified at Section 5.5.4 of 3GPP TS 36.331 could be used to determine whether a detected cell is considered to meet the one or more cell signal conditions for cell change for the UE 8, depending on whether another cell already meets the cell signal conditions for cell change for UE 8. Other examples of alternative events that could be used include: other connected mode events such as e.g. Event A3 specified at Section 5.5.4 of 3GPP TS 36.331; and idle mode reselection events.

If the UE processor 34 determines that a cell meeting the cell signal conditions for cell change for UE 8 (e.g. fulfilling the event trigger for an existing defined event such as the A3, A4 and A6 events mentioned above) is included in a set of configured potential secondary cells for the UE 8 (by comparing the PCID derivable from the reference signals for the detected cell against PCIDs of configured potential secondary cells stored in memory 32), the UE processor 34 configures memory 32 to store the PCID of the detected cell as a configured secondary cell (SCell) meeting the cell signal conditions for cell change (which stored information can be used, as discussed below, when detecting another cell meeting the cell signal conditions for cell change and making a determination whether to report the another cell to the network), and the cell can now be activated as a secondary cell for carrier aggregation (by means of MAC (medium access control) signalling from the network via the primary cell) without any further configuration procedure. Example techniques for how UE may obtain the necessary configuration information to make measurements for a cell within the cluster, access a cell within the cluster and operate in a cell within the cluster are described above.

If a cell newly meeting the cell signal conditions for cell change for UE 8 is identified as a configured secondary cell, the processor 34 additionally compares the PCID for the detected cell against the PCIDs stored at memory 32 for one or more sets of configured potential secondary cells that include one or more cells that are currently reported to the macro eNB 4 as meeting the cell signal conditions for carrier aggregation for UE 8 (STEP 402).

If the detected cell PCID is not included in these one or more secondary cell sets (or no cell is currently reported to the macro eNB as meeting the cell signal conditions for cell change for UE 8), the processor 34 generates and transmits via RF front end 36 and antenna 38 a radio signal comprising a measurement report identifying the detected cell PCID as a cell meeting the cell signal conditions for cell change for UE 8 (STEP 404). For the example of a six cell cluster illustrated in FIG. 1, the UE processor 34 transmits a measurement report identifying one of the six small cells as a cell newly meeting the cell signal conditions for cell change for UE 8, only if none of the other six small cells are currently reported to the network as meeting the cell signal conditions for cell change for UE 8.

Similarly, the UE processor 34 is configured to transmit a report that a cell stops meeting the cell signal conditions for cell change for UE 8, only if no other cell in the same secondary cell set currently meets the cell signal conditions for cell change for UE 8. For the six cell cluster example illustrated in FIG. 1, the UE processor 34 transmits a report indicating that one of the six small cells has stopped meeting the cell signal conditions for cell change for UE 8, only if none of the other six small cells are currently reported to the network as meeting the cell signal conditions for cell change for UE 8.

The macro eNB processor 20 detects the measurement report from UE 8 via antenna 26 and RF front end 24 (STEP 504), and stores the PCID of the cell identified as meeting the cell signal conditions for cell change at memory 22.

On the other hand, if the UE processor 34 determines that the detected cell PCID is included in the above-mentioned one or more cell sets (i.e. the detected cell PCID is in a cell set including a cell that is currently reported to the network as meeting the one or more cell signal conditions for cell change for UE 8), the UE processor 34 is configured not to inform the network that the detected cell meets the cell signal conditions for cell change (STEP 406).

The macro eNB processor 20 monitors radio signals from UE 8 for an indication from UE 8 that a cell in the same cell set as the reported cell no longer meets the cell signal conditions for cell change (STEP 506). So long as the macro eNB processor 20 detects no such indication from UE 8, the macro eNB processor 20 operates on the basis that at least one of the same set of secondary cells meets the cell signal conditions for cell change for the UE 8 (STEP 508), and retains in macro eNB memory 22 an indication (based on the earlier report from the UE 8 that UE has detected a cell within the cluster meeting the cell signal conditions for cell change) that at least one of the same set of secondary cells meets the cell signal conditions for cell change for the UE 8. On the other hand, if the macro eNB processor 20 does detect such an indication (i.e. an indication that a cell in the same cell set as the reported cell no longer meets the cell signal conditions for cell change) from UE 8, the macro eNB processor 36 operates on the basis that none of said same set of secondary cells meets the cell signal conditions for cell change for the UE 8, and reconfigures memory 22 accordingly (STEP 510).

The above-described technique enables a clear decrease in the need for secondary cell (SCell) management in terms of configurations and detailed updating/exchange of SCell configuration messages between eNBs and between primary eNB and UE. The above-described technique also enables a reduction of the over-the-air signalling load by reducing reporting messages from the UE and configuration messages from the macro eNB. For example, there is less need for UE 8 to report all detections of cells meeting cell signal conditions for cell change for UE 8, and there is no need for network to transmit a RRM configuration message for each cell detected at UE 8 that can be used for multiple carrier transmission (e.g. carrier aggregation) for the UE; and this can also reduce the length of time between a secondary cell being detected at the UE and the network and UE being ready for multiple carrier transmission (e.g. carrier aggregation) using the secondary cell.

The above-described technique may be particularly beneficial when there is possibility for multiple carrier transmission (e.g. carrier aggregation/dual connectivity) involving a relatively high number of component carriers.

An embodiment has been described above for the example of each cell of a secondary cell cluster being operated via a respective eNB, but a secondary cell cluster may comprise two or more cells operated via the same eNB. Furthermore, the six cells of the secondary cluster in the example above collectively provide a contiguous coverage area, but one or more individual cells of the cluster may have a coverage area that does not overlap with any of the other cells in the same cluster.

The above detailed description refers to multiple carrier data transmissions via e.g. the primary cell and one or more secondary cells, but the same technique is also applicable, for example, to reporting secondary cell availability for the purpose of data transmission via only one or more secondary cells.

Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the modifications explicitly mentioned above, it will be evident to a person skilled in the art that various other modifications of the described embodiment may be made within the scope of the invention.

1. A method comprising: detecting at a communication device a first cell meeting one or more cell signal conditions for secondary cell transmission for the communication device, which communication device is currently served by at least a primary cell of a cellular network; determining whether the first cell belongs to a set of potential secondary cells for the communication device including another cell that the communication device has currently reported to the cellular network as meeting one or more cell signal conditions for secondary cell transmission for the communication device; and deciding whether to report said first cell to said cellular network dependent on the result of said determining.

2. A method according to claim 1, wherein said set of potential secondary cells consists of cells operating at the same carrier frequency.

3. A method according to claim 1, wherein said set of potential secondary cells consists of cells whose total collective coverage area is contiguous.

4. A method according to claim 1, wherein said one or more cell signals conditions for secondary cell transmission comprise one or more cell signal conditions for cell change.

5. A method comprising: transmitting for a communication device served by at least a primary cell of a cellular network an identification of at least one set of potential secondary cells for the communication device, wherein said identification is an indication to the communication device not to automatically report movement between cells in the same set of potential secondary cells.

6. A method according to claim 5, wherein each set of potential secondary cells consists solely of cells operating at the same carrier frequency.

7. A method according to claim 5, wherein each set of potential secondary cells consists solely of cells whose total collective coverage area is contiguous.

8. A method according to claim 5, comprising: monitoring radio signals from the communication device for an indication that one cell in a set of potential secondary cells meets one or more cell signal conditions for secondary cell transmission.

9. A method according to claim 8, comprising: in response to detecting an indication that one cell in a set of potential secondary cells meets one or more cell signal conditions for secondary cell transmission, monitoring radio signals from the communication device that a cell in the same set of potential secondary cells has stopped meeting one or more cell signal conditions for secondary cell transmission.

10. A method according to claim 8, wherein said one or more cell signals conditions for secondary cell transmission comprise one or more cell signal conditions for cell change.

11. An apparatus comprising: a processor and memory including computer program code, wherein the memory and computer program code are configured to, with the processor, cause the apparatus to: detect at a communication device a first cell meeting one or more cell signal conditions for secondary cell transmission for the communication device, which communication device is currently served by at least a primary cell of a cellular network; determine whether the first cell belongs to a set of potential secondary cells for the communication device including another cell that the communication device has currently reported to the cellular network as meeting one or more cell signal conditions for secondary cell transmission for the communication device; and decide whether to report said first cell to said cellular network dependent on the result of said determining.

12. An apparatus to claim 11, wherein said set of potential secondary cells consists of cells operating at the same carrier frequency.

13. An apparatus according to claim 11, wherein said set of potential secondary cells consists of cells whose total collective coverage area is contiguous.

14. An apparatus according to claim 11, wherein said one or more cell signals conditions for secondary cell transmission comprise one or more cell signal conditions for cell change.

15. An apparatus comprising: a processor and memory including computer program code, wherein the memory and computer program code are configured to, with the processor, cause the apparatus to: transmit for a communication device served by at least a primary cell of a cellular network an identification of at least one set of potential secondary cells for the communication device, wherein said identification is an indication to the communication device not to automatically report movement between cells in the same set of potential secondary cells.

16. An apparatus according to claim 15, wherein each set of potential secondary cells consists solely of cells operating at the same carrier frequency.

17. An apparatus according to claim 15, wherein each set of potential secondary cells consists solely of cells whose total collective coverage area is contiguous.

18. An apparatus according to claim 15, wherein the memory and computer program code are further configured to, with the processor, cause the apparatus to: monitor radio signals from the communication device for an indication that one cell in a set of potential secondary cells meets one or more cell signal conditions for secondary cell transmission.

19-22. (canceled)

23. A computer program product comprising a non-transitory computer-readable medium having program code thereon, which when loaded into a computer controls the computer to perform the method of claim 1.

24. A computer program product comprising a non-transitory computer-readable medium having program code thereon, which when loaded into a computer controls the computer to perform the method of claim 5.
